(19) United States
(12) Patent Application Publication
(10) Pub. No.: US 2024/0400005 A1
(43) Pub. Date: Dec. 5, 2024

(54) Distribution Device and Liquid Distribution Actuator

(71) Applicant: Vitesco Technologies GmbH, Regensburg (DE)

(72) Inventors: Wolf Goetze, Rotenburg (DE); Matthias Fischer, Ringgau (DE)

(73) Assignee: Vitesco Technologies GmbH, Regensburg (DE)

(21) Appl. No.: 18/806,411

(22) Filed: Aug. 15, 2024

Related U.S. Application Data
(63) Continuation of application No. PCT/EP2023/052934, filed on Feb. 7, 2023.

(30) Foreign Application Priority Data
Feb. 24, 2022 (DE) 10 2022 201 945.8

(51) Int. Cl. B60S 1/54; B60S 1/48

(52) U.S. Cl. CPC B60S 1/54; B60S 1/481

(57) ABSTRACT

A distribution device including: —a housing having an inlet port and a plurality of outlet ports and—an electromotively drivable, rotatably adjustable distributor which is arranged in the housing in the form of a disk on which liquid-receiving and liquid-guiding means are formed. The distributor disk is rotatably adjustable into defined positions relative to the housing here. The liquid-receiving and liquid-guiding means here include an end-face radial groove which directs the liquid to the desired locations in the distribution device. In this case, the distribution device additionally has a sensor arrangement for determining the position of the radial groove, wherein the sensor arrangement has a signal transducer which is fixed in position with respect to the housing and a metallic counterpart element which is fixed in position with respect to the distributor disk and interacts with the signal transducer.

### CROSS-REFERENCE TO RELATED APPLICATIONS

This application claims priority to PCT Application PCT/EP2022/052934, filed Feb. 7, 2023, which claims priority to German Patent Application No. DE 10 2021 201 945.8, filed Feb. 24, 2022. The disclosures of the above applications are incorporated herein by reference.

### FIELD OF THE INVENTION

The invention relates to a distribution device for a liquid distribution actuator and to a liquid distribution actuator having such a distribution device. The invention also proposes a cleaning apparatus, a vehicle, and the use of a sensor arrangement.

### SUMMARY OF THE INVENTION

It is an object of the invention to improve a distribution of water for a vehicle cleaning arrangement, specifically in view of the increasing number of vehicle sensors.

This object is achieved by way of a distribution device proposed and described. A liquid distribution actuator having such a distribution device is also proposed and described. Furthermore, a cleaning apparatus and a vehicle are proposed and described. The invention furthermore proposes uses of a sensor arrangement. Various embodiments of the invention are the subject matter described.

The invention proposes a distribution device for supplying a pressurized liquid to individual cleaning locations on a vehicle.

In this case, the distribution device has a housing having an inlet port and a plurality of outlet ports and an electromotively drivable, rotatably adjustable distributor which is arranged in the housing in the form of a disk on which a liquid-receiver and liquid-guide are formed.

Here, the distributor disk is rotatably adjustable into defined positions relative to the housing in order to allow liquid supply via the individual outlet ports.

The liquid-receiver and liquid-guide include in this case an end-face radial groove or an end-face radial channel which directs or guides the liquid to the desired locations in the distribution device.

In this case, “end-face” is to be understood at least to mean that a radial groove, which extends into the distributor disk only by a certain amount, may be provided on both faces of the distributor disk or on the end faces of the distributor disk. That is to say that these two radial grooves are opposite each other and are separated from each other by a wall of the distributor disk between them.

As an alternative to this, “end-face” is to be understood to mean that the radial groove may be designed in the form of a so-called radial through-groove which extends per se between two end surfaces of the distributor disk or from end face to end face of the distributor disk, that is to say in a longitudinal direction of the distributor disk through the distributor disk or over the entire height or thickness thereof.

In this case, the distribution device additionally has a sensor arrangement for determining the position of the radial groove.

In this case, the sensor arrangement has a signal transducer, which is fixed in position with respect to the housing, and a metallic portion—in the sense of a counterpart element to the signal transducer-which is fixed in position with respect to the distributor disk and interacts with the signal transducer and may be, for instance, magnetic, for example ferromagnetic.

In one embodiment, this signal transducer is designed in the form of an inductive signal transducer.

In a further embodiment, this signal transducer is designed in the form of a Hall sensor.

In this case, a cleaning location is understood to mean a cleaning location which is associated with a vehicle sensor. Here, this cleaning location need not itself be part of the sensor, but may be arranged at a distance from the sensor, for example may be a location on a windshield or the like. The cleaning location may however also be part of a vehicle sensor, for example a cleaning location associated with a camera. A cleaning location may however also be another location on the vehicle which is not associated with a vehicle sensor as such, for example another location on the windshield, a location on a headlight and the like.

Here, in the simplest case, a liquid or cleaning liquid may be understood to mean water, or an aqueous cleaning agent solution, that is to say water in combination with a cleaning agent additive. Here, the cleaning agent solution may also contain an antifreeze agent, which as such lowers the freezing point of the cleaning agent solution.

For further illustration of the water distribution mechanism proposed, reference is hereby made to the German patent applications bearing the application file references DE10 2021 208 936.4 and DE10 2021 210 883.0, the present disclosure being based on and being a further development of these patent applications.

These two patent applications provide different refinements of the distributor disk and its radial groove, the position of which relative to the housing of the distribution devices is to be determined-within the scope of the present disclosure.

In this respect, these two patent applications DE10 2021 208 936.4 and DE10 2021 210 883.0 are hereby also incorporated in the content of disclosure of the present description.

The invention also proposes a liquid distribution actuator which includes a distribution device or distributing device of the type described above and an electric motor for driving the rotatably adjustable distributor of the distribution device.

The invention additionally proposes a cleaning apparatus or a cleaning system for a vehicle for cleaning a large number of cleaning locations on the vehicle, wherein the cleaning apparatus or the cleaning system includes at least one liquid distribution actuator of the type described above.

Furthermore, the invention also proposes a vehicle having a cleaning apparatus of the type described above.

A vehicle is to be understood here to mean any type of vehicle that is operated either by internal combustion engine and/or electric motor, such as passenger motor vehicles and/or utility vehicles. These are partially autonomously and may be fully autonomously operated vehicles.

The invention also proposes the use of a sensor arrangement of the type described above for determining the position of the radial groove of the distributor disk relative to the housing accommodating it, wherein, for determining the position of the radial groove, a conveying pump which is fluidically connected to the distribution device is not operated or is disabled or not actuated for the duration of the position determination process.

In this case, the position of the radial groove may be determined again at defined time intervals and/or in a manner triggered by a defined event.

The invention also proposes the use of a sensor arrangement of the type described above for determining the position of the radial groove of the distributor disk relative to the housing accommodating it, wherein undesired application of a liquid to an outlet port, associated with the radial groove in the critical position, of the distribution device is avoided in a critical position, identified by sensor, of the radial groove in which the transducer interacts with the counterpart element or there is no such interaction and in which there is no corresponding driver request for application of liquid.

The undesired application of liquid is avoided or does not occur here by way of a conveying pump which is fluidically connected to the distribution device being switched off by the control system.

In addition or as an alternative to this, the undesired application of liquid is avoided or does not occur here by way of a shut-off element associated with the outlet port being actuated by the control system. The shut-off element may be, for example, a shut-off element, which is associated with a nozzle, in the region of a windshield.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The invention is explained in detail below with reference to the illustrations in the figures. Further developments of the invention can be found in the following description of preferred embodiments. In this respect:

FIG. 1 shows a sectional illustration of a proposed distribution device of a liquid distribution actuator;

FIG. 2 shows a perspective view of the distributor disk shown in FIG. 1; and

FIG. 3 shows a perspective view of the counterpart element, shown in FIG. 1, to the transducer.

### DETAILED DESCRIPTION OF THE PREFERRED EMBODIMENTS

The following description of the preferred embodiment(s) is merely exemplary in nature and is in no way intended to limit the invention, its application, or uses.

The proposed liquid distribution actuator A serves to supply a pressurized liquid or cleaning liquid to individual cleaning locations of a vehicle.

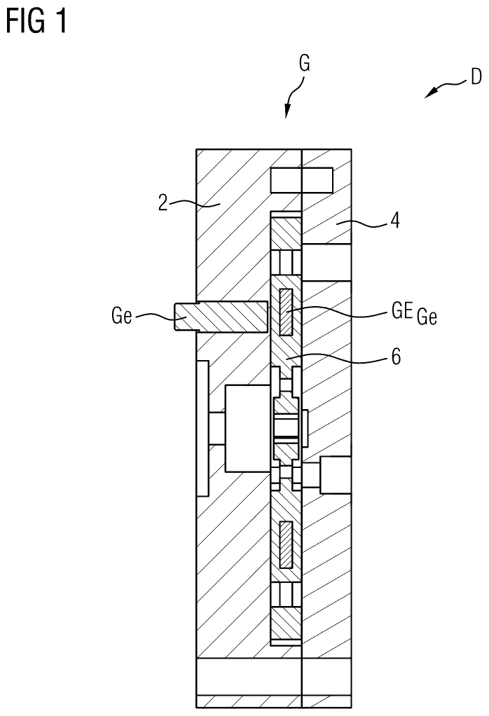

In this case, the actuator A includes a distribution or distributing device D having a, for example, substantially cylindrical housing G which has, for example, a first housing part 2 and a second housing part 4. In this case, these two housing parts 2, 4 form, in the joined state, a housing chamber in which a distributor 6 in the form of a disk with a radial through-groove DN is arranged in a rotatably adjustable manner (FIG. 1). The two housing parts 2, 4 and the distributor disk 6 are produced in this case, for example, from a thermoset or a thermoplastic—for instance a PPS-GF material.

The actuator A also includes an electric motor or E-motor—not illustrated here—which is joined or screw-connected, for example, to the housing part 2. The housing part 4 however is, for example, screw-connected to the housing part 2. As an alternative to screw connection, these housing parts 2, 4 may also be rolled with respect to each other for example, for instance by a sheet-metal casing. Such a rolled arrangement could in this case also include the E-motor, for example. The E-motor is, for example, in the form of a dry rotor here. As an alternative to this, the E-motor may also be designed as a wet rotor and in this case have a containment shell or a can which separates a wet chamber from a dry chamber and in which conveyed liquid washes around or flows around the rotor of the E-motor (wet chamber). However, the stator of the E-motor is located in the dry chamber here. In this case, a shaft—not illustrated here—of the electric motor E extends through the housing part 2 and a sealing element—not illustrated here—which is arranged in the housing part 2 and in this case provides sealing with respect to the housing part 2 and the shaft, as far as into the distributor 6 or the distributor disk 6, wherein the shaft end—not illustrated here—engages into the distributor disk 6 in a positively locking manner.

FIG. 1 additionally illustrates a sensor arrangement having a signal transducer Ge, for instance in the form of an inductive signal transducer or a Hall sensor, which is arranged fixed in position in the housing part 2 and interacts with a metallic portion or counterpart element GE_{Ge} (GE_{Ge}=signal transducer counterpart element or counterpart element to the signal transducer or transducer Ge) integrated into the distributor disk 6 in order to be able to determine the position or orientation of the distributor disk 6 or the radial groove DN (DN=radial through-groove), which directs or guides the liquid to the desired locations in the distribution device D or to the individual outlets or outlet ports of the distribution device D, relative to the housing G and a critical position or orientation.

In this case, the signal transducer Ge extends from a first end face of the housing part 2 as far as into a region close to a second end face of the housing part 2, wherein the second end face jointly delimits a chamber accommodating the distributor disk 6. In this case, the signal transducer Ge is inserted into the housing part 2 or encapsulated with the plastic of the housing part 2.

Here, a critical position or orientation—in the sense of an absolute reference position—is to be understood to mean a position or orientation of the distributor disk 6 or the radial groove RN of the distributor disk 6 relative to one of the outlets or outlet ports via which, for example, a windshield of a vehicle or a region of such a windshield is undesirably supplied with or has applied to it the liquid or cleaning liquid, if counting by a counter during (or for) actuation of the E-motor is performed incorrectly or improperly. Here, “undesirably” means that a corresponding driver request for applying liquid to the windshield is not made or is not present.

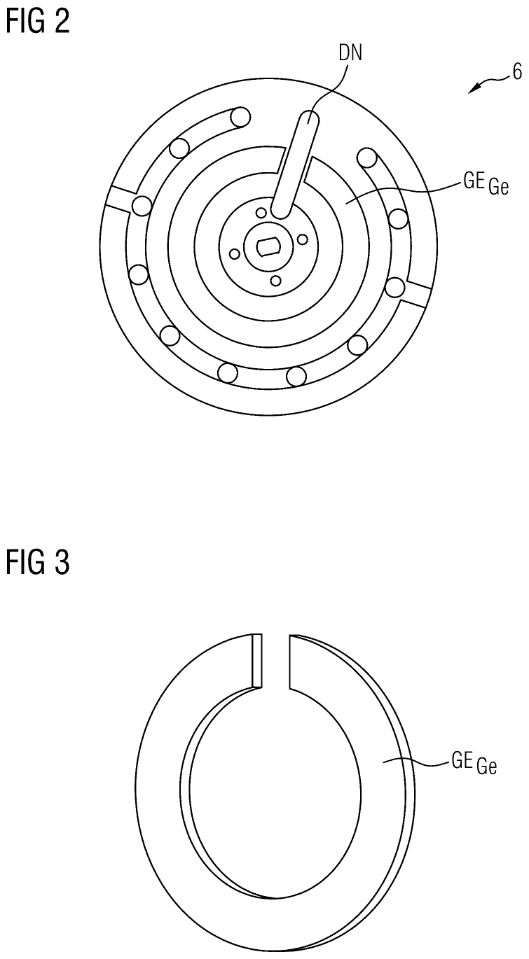

FIG. 2 indicates here-within the meaning of a possible embodiment—the extent of the metallic counterpart element GE_{Ge} shown in FIG. 1, specifically in the circumferential direction of the distributor disk 6. Here, this counterpart element GE_{Ge} is, for example, in the form of a slotted ring element which is covered or enclosed or encapsulated by the plastics material of the distributor disk 6. Therefore, this counterpart element GE_{Ge} is merely indicated in FIG. 2.

This annular counterpart element GE_{Ge} (FIG. 3) which is slotted—or runs in a non-closed circle—is arranged in the distributor disk 6 in such a way that the radial groove DN, which may be designed in the form of a radial through-groove (DN=through-groove) for instance, is situated in a region of the distributor disk 6 between the two ends of this counterpart element GE_{Ge} (FIG. 2).

Here, specifically the slotted region of the counterpart element GE_{Ge} prevents interaction with the transducer Ge, so that a position or orientation of the distributor disk 6 or the radial groove DN relative to the housing G or to the individual outlet ports on the housing part 4 may be determined therefrom.

As an alternative to such an annular, slotted design, the counterpart element GE_{Ge} may also be designed to be comparatively short and arranged at any point on the distributor disk 6 (not illustrated by the figures) in order to be able to interact with the transducer Ge, for instance in a region close to the radial groove DN.

In this case, specifically this interaction between the counterpart element GE_{Ge} and the transducer Ge creates a signal required for the determination of the position or orientation.

In addition or as an alternative to such a metallic portion or element or counterpart element described above which is enclosed by the plastic of the distributor disk 6 or is encapsulated with plastic, a magnetized plastic portion or a magnetized plastic track/sensor track may also be provided on the distributor disk 6, the portion or track correspondingly interacting with the transducer Ge.

At this point, reference is once again made to the two German patent applications—already mentioned at the outset-bearing the application file references DE10 2021 208 936.4 and DE10 2021 210 883.0, the present disclosure being based on and being a further development of these patent applications. In this respect, these two patent applications DE10 2021 208 936.4 and DE10 2021 210 883.0 are hereby also incorporated in the content of disclosure of this present description.

DE 10 2021 208 936.4 discloses a distributor disk 6 with a radial groove or radial through-groove DN in the form of a closed profile—this profile being closed in the radial direction of the distributor disk 6—whereas DE 10 2021 210 883.0 discloses a distributor disk 6 with a radial groove or radial through-groove DN in the form of an open profile—this profile being open in the radial direction of the distributor disk 6.

The invention proposes using the sensor arrangement described above for determining the position of the radial groove DN of the distributor disk 6—relative to the housing G accommodating it—and in so doing not operating a conveying pump, which is fluidically connected to the distribution device D, or disabling or not actuating the conveying pump for the duration of the position determination process.

Since this position determination is carried out regularly or repeatedly, for instance at regular time intervals and/or in a manner initiated by defined events, for instance after a definable number of driving cycles and/or after a definable mileage, faulty or incorrect step operation of the E-motor due to incorrect counting by a counter during (or for) actuation of the E-motor is avoided.

Owing to such regular position determination, correct step operation of the E-motor or correct counting by the counter during (or for) actuation of the E-motor is ensured and undesired application of liquid—or application of liquid not prompted by a vehicle driver—to the windshield may be avoided. Such an undesired event could specifically cause a safety-critical driving situation which should be avoided.

Based on the knowledge of the above-described critical position of the radial groove DN of the distributor disk 6 in the sense of an absolute reference position, the distributor disk 6 is correctly rotatably adjusted to the desired position in steps by electric motor—directly or indirectly—and the liquid is applied or supplied to a correspondingly associated outlet or outlet port—not illustrated here—on the distributor housing 4.

One aspect of the proposed sensor arrangement is that, with knowledge of the position of the radial groove DN on the one hand and in the absence of a driver request for application of liquid on the other, undesired application of liquid to an outlet port, which is associated with the radial groove DN in the critical position, of the distribution device D is suppressed or avoided by way of, for instance, a conveying pump which is fluidically connected to the distribution device being switched off. In addition or as an alternative to this, a shut-off element which is associated with the outlet port is actuated, for instance in the form of a shut-off element which is associated with a nozzle in the region of a windshield.

Although, in the preceding description, exemplary embodiments are explained, it should be noted that a large number of modifications are possible. It should be noted, furthermore, that the exemplary embodiments are merely examples which are in no way intended to limit the scope of protection, the applications, and the structure. Instead, the above description gives a person skilled in the art a guideline for the implementation of at least one exemplary embodiment, it being possible to make various changes, especially with regard to the function and arrangement of the component parts described, without departing from the scope of protection as emerges from the combinations of features that are equivalent thereto.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A distribution device comprising:
a housing further comprising:
an inlet port;
a plurality of outlet ports;
an electromotively drivable, rotatably adjustable distributor which is arranged in the housing in the form of a disk on which a liquid-receiver and a liquid-guide are formed, the liquid receiver and liquid guide further comprising:
an end-face radial groove which directs the liquid to the desired locations in the distribution device;
a sensor arrangement for determining the position of the radial groove (DN), the sensor arrangement further comprising:
a signal transducer which is fixed in position with respect to the housing; and
a metallic portion which is fixed in position with respect to the distributor disk and interacts with the signal transducer;
wherein the distributor disk is rotatably adjustable into defined positions relative to the housing in order to allow liquid supply via the individual outlet ports.

2. The distribution device of claim 1, wherein the signal transducer is designed in the form of an inductive signal transducer.

3. The distribution device of claim 1, wherein the signal transducer is designed in the form of a Hall sensor.

4. A liquid distribution actuator, comprising:
a distribution device of claim 1; and
an electric motor for driving the rotatably adjustable distributor of the distribution device.

5. A cleaning apparatus for a vehicle for cleaning a large number of cleaning locations on the vehicle, wherein the cleaning apparatus has at least one liquid distribution actuator of claim 4.

6. A vehicle having a cleaning apparatus of claim 5.

7. The distribution device of claim 1, wherein the sensor arrangement is used for determining the position of the radial groove of the distributor disk relative to the housing, and, for position determination, a conveying pump which is fluidically connected to the distribution device is deactivated.

8. The distribution device of claim 7, wherein the position of the radial groove is determined again at defined time intervals.

9. The distribution device of claim 7, wherein the position of the radial groove (DN) is determined again in a manner triggered by a defined event.

10. The distribution device of claim 1, wherein the sensor arrangement is used for determining the position of the radial groove of the distributor disk relative to the housing, wherein undesired application of a liquid to an outlet port, associated with the radial groove in the critical position, of the distribution device is avoided in a critical position, identified by the sensor arrangement, of the radial groove in which the signal transducer interacts with the counterpart element or there is no such interaction and in which there is no driver request for application of liquid.

11. The distribution device of claim 10, further comprising a conveying pump, wherein the undesired application of liquid is avoided by way of the conveying pump which is fluidically connected to the distribution device being switched off.

12. The distribution device of claim 10, wherein the undesired application of liquid is avoided by way of a shut-off element associated with the outlet port being actuated.
